(19) United States
(12) Patent Application Publication
(10) Pub. No.: US 2026/0252602 A1
(43) Pub. Date: Aug. 27, 2026

(54) INFORMATION PROCESSING DEVICE, INFORMATION PROCESSING METHOD, AND NON-TRANSITORY COMPUTER-READABLE MEDIUM

(71) Applicant: NEC Corporation, Tokyo (JP)

(72) Inventors: Joe BRINTON, Tokyo (JP); Masaharu MORIMOTO, Tokyo (JP); Yoshiaki SAKAE, Tokyo (JP); Sianen OOI, Tokyo (JP); Masaki INOKUCHI, Tokyo (JP); Ryosuke HOTCHI, Tokyo (JP); Tatsuya FUKUDA, Tokyo (JP); Shunsuke OSAKI, Tokyo (JP)

(73) Assignee: NEC Corporation, Tokyo (JP)

(21) Appl. No.: 19/532,374

(22) Filed: Feb. 6, 2026

(30) Foreign Application Priority Data
Feb. 21, 2025 (JP) 2025-027138

(51) Int. Cl. G06F 16/3329

(52) U.S. Cl. CPC G06F 16/33295

(57) ABSTRACT

An object is to prevent an answer that does not conform to a user's intention from being generated. An information processing device includes a reception unit that receives input for a machine-learned generative model, and an identification unit that identifies a pair of a re-entered input with content changed and an answer of the generative model to the input in input/output history of the generative model as a non-reference pair that is not to be referred to in generation of the answer or a non-reference candidate pair that is a candidate not to be referred to in generation of the answer. In a case where the non-reference candidate pair is identified, whether to cause the generative model to refer to the non-reference candidate pair can be left to decision making of the user.

### INCORPORATION BY REFERENCE

This application is based upon and claims the benefit of priority from Japanese patent application No. 2025-027138, filed on February 21, 2025, the disclosure of which is incorporated herein in its entirety by reference.

### TECHNICAL FIELD

The present disclosure relates to an information processing device, an information processing method, and an information processing program.

### BACKGROUND ART

A technique for performing natural language processing such as questions and answers using a large language model (LLM) is known. If a question sentence written in a natural language is input to the LLM as a prompt, an answer sentence in a natural language to the question sentence is output from the LLM, so that the LLM user can ask and answer questions with the LLM in the same sense as in a case of interacting with a person.

A related art related to LLM includes, for example, that described in JP 2024-162602 A below. JP 2024-162602 A discloses a sentence generation device capable of generating a prompt in which a valid sentence is added to an input question sentence as reference information within a predetermined number limit.

### SUMMARY

In a system that causes a generative model such as LLM to generate output data, it is possible to generate output data for new input data based on a series of pieces of input data for the generative model and history of output data for the pieces of input data. In a system that causes a generative model to generate an answer, after output data for a certain piece of input data is generated, content of the input data is changed, and thus the input data can be re-entered.

Here, in a case where the content of the past input data is changed, and re-entry is enabled, if an answer based on the input/output history is generated, the input data before the content change and the output data corresponding to the input data can be reflected in the generated output data. However, it is considered that the input data of which the content has been changed and the output data related to the input data do not conform to the user's intention. For this reason, in a case where the input data of which content has been changed and the output data related to the input data are referred to at the time of generating new output data for the new input data, there is a possibility that the new output data does not conform to the user's intention.

An example object of the present disclosure is to provide a technique capable of reducing the possibility that output data generated by a generative model does not conform to a user's intention.

An information processing device according to an example aspect of the present disclosure includes reception means for receiving input data for a generative model that generates output data associated with the input data, and identification means for identifying a pair of input data that is a target of content change and output data generated according to the input data before the content change in input/output history of the generative model, as a non-reference pair not to be referred to in the generation of the output data associated with the input data received by the reception means or a non-reference candidate pair that is a candidate not to be referred to in the generation of the output data associated with the input data received by the reception means.

In an information processing method according to an example aspect of the present disclosure, at least one processor performs reception processing of receiving input data for a generative model that generates output data associated with the input data, and identification processing of identifying a pair of input data that is a target of content change and output data generated according to the input data before the content change in input/output history of the generative model, as a non-reference pair not to be referred to in the generation of the output data associated with the input data received in the reception processing or a non-reference candidate pair that is a candidate not to be referred to in the generation of the output data associated with the input data received in the reception processing.

An information processing program according to an example aspect of the present disclosure causes a computer to function as reception means for receiving input data for a generative model that generates output data associated with the input data, and identification means for identifying a pair of input data that is a target of content change and output data generated according to the input data before the content change in input/output history of the generative model, as a non-reference pair not to be referred to in the generation of the output data associated with the input data received by the reception means or a non-reference candidate pair that is a candidate not to be referred to in the generation of the output data associated with the input data received by the reception means.

According to an illustrative aspect of the present disclosure, an illustrative effect of enabling reduction of the possibility that the output data generated by the generative model does not conform to the user's intention can be exhibited.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram illustrating a configuration of an information processing device according to the present disclosure;

FIG. 2 is a flowchart illustrating a flow of an information processing method according to the present disclosure;

FIG. 3 is a block diagram illustrating a configuration of another information processing device according to the present disclosure;

FIG. 4 is a diagram illustrating a display example of a question and an answer;

FIG. 5 is a diagram illustrating an example of input/output history;

FIG. 6 is a diagram illustrating an example of a method of causing a generative model to refer to input/output history excluding a non-reference pair;

FIG. 7 is a diagram illustrating an example of a display screen for presenting a non-reference candidate pair to a user;

FIG. 8 is a flowchart illustrating a flow of processing in a case where the information processing device illustrated in FIG. 3 records a non-reference pair or a non-reference candidate pair;

FIG. 9 is a flowchart illustrating a flow of processing executed if the information processing device illustrated in FIG. 3 receives input data in a case where a pair that is a target of content change is recorded as a non-reference pair;

FIG. 10 is a flowchart illustrating a flow of processing executed if the information processing device illustrated in FIG. 3 receives input data in a case where a pair that is a target of content change is recorded as a non-reference candidate pair; and

FIG. 11 is a block diagram illustrating a configuration of a computer that functions as the information processing device according to the present disclosure.

### EXAMPLE EMBODIMENTS

Hereinafter, example embodiments of the present disclosure are exemplified. However, the present disclosure is not limited to the following illustrative example embodiments, and various modifications may be made within the scope described in the claims. For example, the example embodiments obtained by appropriately combining techniques (some or all of objects or methods) adopted in the following illustrative example embodiments may also fall within the scope of the present disclosure. Example embodiments obtained by appropriately omitting some of the techniques adopted in the following illustrative example embodiments may also fall within the scope of the present disclosure. Effects mentioned in the following illustrative example embodiments are examples of effects expected in the illustrative example embodiments and do not define extension of the present disclosure. That is, example embodiments that do not exert the effects mentioned in the following illustrative example embodiments may also fall within the scope of the present disclosure.

### FIRST ILLUSTRATIVE EXAMPLE EMBODIMENT

A first illustrative example embodiment, that is an example of the example embodiments of the present disclosure, is described in detail with reference to the drawings. The present illustrative example embodiment is a basic form of each of the illustrative example embodiments described below. An application range of each technique adopted in the present illustrative example embodiment is not limited to the present illustrative example embodiment. That is, each technique adopted in the present illustrative example embodiment can also be adopted in another illustrative example embodiment included in the present disclosure within a range in which no particular technical problem occurs. Each technique illustrated in the drawings referred to for describing the present illustrative example embodiment may also be adopted in another illustrative example embodiment included in the present disclosure within a range in which no particular technical problem occurs.

### Configuration of Information Processing Device 1

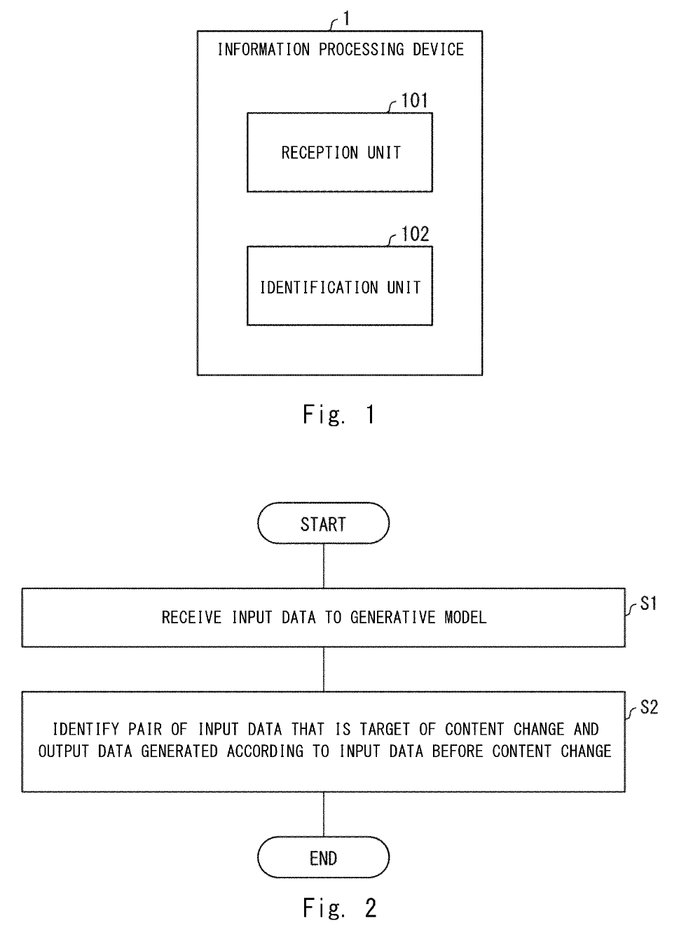

A configuration of an information processing device 1 according to the present illustrative example embodiment is described with reference to FIG. 1. FIG. 1 is a block diagram illustrating the configuration of the information processing device 1. As illustrated in FIG. 1, the information processing device 1 includes a reception unit 101 and an identification unit 102.

The reception unit 101 receives input data for a generative model that generates output data associated with the input data. Here, “input data” means data input to cause the generative model to generate output data and can be rephrased as “prompt”, “query”, “command”, “instruction”, and the like. The reception unit 101 receives input data in a format associated with the generative model. For example, in a case where a generative model to which text data described in a natural language can be input is used, the reception unit 101 receives input data in a text format described in a natural language. For example, in a case of using a generative model capable of inputting image data, such as a generative model that generates text data describing a content of an input image, the reception unit 101 may receive input of image data.

“Generative model” is a trained model subjected to machine learning to output output data associated with input data. The output data generated by the generative model is any piece of data. For example, the generative model may generate at least any one of text data, image data (may be still image data or may be moving image data), and voice data.

The identification unit 102 identifies a pair of the input data that is a target of content change and the output data generated according to the input data before the content change in the input/output history of the generative model as a non-reference pair that is not referred to in the generation of the output data associated with the input data received by the reception unit 101.

Alternatively, the identification unit 102 may identify a non-reference candidate pair instead of identifying a non-reference pair. The difference between the non-reference pair and the non-reference candidate pair is that the former is determined not to be referred to in the generation of the output data, while the latter is a candidate not to be referred to in the generation of the output data but is not determined not to be referred to. Whether to cause the generative model to refer to the non-reference candidate pair in the generation of the output data may be determined, for example, according to the selection of the user.

As described above, the information processing device 1 according to the present illustrative example embodiment adopts a configuration including: the reception unit 101 that receives input data for a generative model that generates output data associated with the input data, and the identification unit 102 that identifies a pair of input data that is a target of content change and output data generated according to the input data before the content change in the input/output history of the generative model, as a non-reference pair not to be referred to in the generation of the output data associated with the input data received by the reception unit 101 or a non-reference candidate pair that is a candidate not to be referred to in the generation of the output data associated with the input data received by the reception unit 101.

Here, the content of the input data is often changed in a case where the user notices an error in the input data, or the generated output data does not conform to the intention of the user. Therefore, it can be said that there is a high possibility that a pair of the input data that is a target of the content change and the output data generated according to the input data before the content change includes content that does not conform to the intention of the user.

Therefore, the information processing device 1 adopts a configuration in which a pair of input data that is a target of a content change and output data generated according to the input data before the content change in the input/output history of the generative model is identified as a non-reference pair or a non-reference candidate pair.

As a result, a non-reference pair or a non-reference candidate pair possibly having a content that does not conform to the intention of the user can be prevented from affecting the generation of the output data associated with the input data received by the reception unit 101. Therefore, according to the information processing device 1, it is possible to reduce a possibility that the output data generated by the generative model does not conform to the intention of the user.

According to the above configuration, since the input/output history excluding the non-reference pair or the non-reference candidate pair can be referred to by the generative model in the generation of the output data, the generative model can be caused to generate the output data of a valid content reflecting the input/output history.

In a case where a pair of the input data that is a target of content change and the output data generated according to the input data before the content change is a non-reference pair, the user can obtain the output data generated without referring to the non-reference pair without performing any operation. Meanwhile, in a case where a pair of the input data that is a target of content change and the output data generated according to the input data before the content change is a non-reference candidate pair, whether to cause the generative model to refer to the non-reference candidate pair can be left to decision making of the user.

### Information Processing Program

The functions of the information processing device 1 described above can also be achieved by a program. The information processing program according to the present illustrative example embodiment causes a computer to function as reception means for receiving input data for a generative model that generates output data associated with the input data, and specification means for identifying a pair of input data that is a target of content change and output data generated according to the input data before the content change in input/output history of the generative model, as a non-reference pair not to be referred to in the generation of the output data associated with the input data received by the reception means or a non-reference candidate pair that is a candidate not to be referred to in the generation of the output data associated with the input data received by the reception means. According to the information processing program, an effect of enabling reduction of the possibility that the output data generated by the generative model does not conform to the intention of the user can be obtained.

### Flow of Information Processing Method

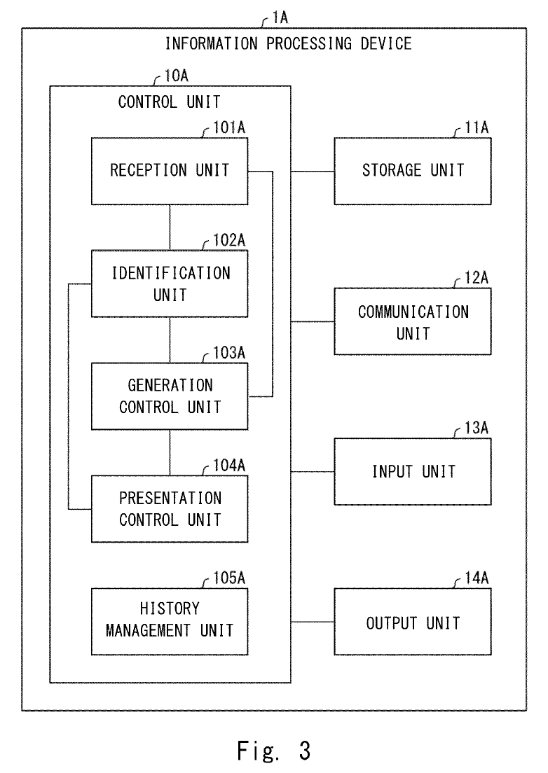

A flow of an information processing method according to the present illustrative example embodiment is described with reference to FIG. 2. FIG. 2 is a flowchart illustrating the flow of the information processing method. An entity executing each step in this information processing method may be a processor included in the information processing device 1, may be a processor included in another device, or entities executing the steps may be processors provided in different devices.

In S1 (reception processing), at least one processor receives input data for a generative model that generates output data associated with the input data.

In S2 (identification processing), at least one processor identifies a pair of the input data that is a target of content change and the output data generated according to the input data before the content change in the input/output history of the generative model as a non-reference pair that is not referred to in the generation of the output data associated with the input data received in S1. In S2, at least one processor may identify the pair of the input data that is the target of content change and the output data generated according to the input data before the content change in the input/output history of the generative model as a non-reference candidate pair that is a candidate not to be referred to in the generation of the output data associated with the input data received in S1.

As described above, the information processing method according to the present illustrative example embodiment employs a configuration in which at least one processor executes: reception processing of receiving input data for a generative model that generates output data associated with the input data; and identification processing of identifying a pair of the input data that is a target of content change and the output data generated according to the input data before the content change in input/output history of the generative model, as a non-reference pair not to be referred to in the generation of the output data associated with the input data received in the reception processing or a non-reference candidate pair that is a candidate not to be referred to in the generation of the output data associated with the input data received in the reception processing. According to the information processing method, an effect of enabling reduction of the possibility that the output data generated by the generative model does not conform to the intention of the user can be obtained.

### SECOND ILLUSTRATIVE EXAMPLE EMBODIMENT

A second illustrative example embodiment, that is an example of the example embodiments of the present disclosure, is described in detail with reference to the drawings. Components having the same functions as the components described in the illustrative example embodiment described above are denoted by the same reference numerals, and descriptions thereof are omitted as appropriate. An application range of each technique adopted in the present illustrative example embodiment is not limited to the present illustrative example embodiment. That is, each technique adopted in the present illustrative example embodiment can also be adopted in another illustrative example embodiment included in the present disclosure within a range in which no particular technical problem occurs. Each technique illustrated in each of the drawings referred to for describing the present illustrative example embodiment can be employed in another illustrative example embodiment included in the present disclosure within a range in which no particular technical problem occurs.

### Configuration of Information Processing Device 1A

A configuration of an information processing device 1A according to the present illustrative example embodiment is described with reference to FIG. 3. FIG. 3 is a block diagram illustrating the configuration of the information processing device 1A. The information processing device 1A is a device having a function of receiving input data by a user, causing a generative model to generate output data associated with the input data, and providing the generated output data to the user. The information processing device 1A may be a local device used by individual users or may be a server that provides a generation service of output data to a plurality of users.

As illustrated, the information processing device 1A includes a control unit 10A that integrally controls units of the information processing device 1A and a storage unit 11A that stores various types of data to be used by the information processing device 1A. The information processing device 1A includes a communication unit 12A for the information processing device 1A to communicate with another device, an input unit 13A for receiving an input to the information processing device 1A, and an output unit 14A for the information processing device 1A to output data. Then, the control unit 10A includes a reception unit 101A, an identification unit 102A, a generation control unit 103A, a presentation control unit 104A, and a history management unit 105A.

Similar to the reception unit 101 of the first illustrative example embodiment, the reception unit 101A receives input data for a generative model that generates output data associated with the input data. Hereinafter, an example in which a language model capable of performing natural language processing is used as the generative model is described, and this language model is referred to as a generative model 2A. The language model capable of performing the natural language processing can be generated by training an arrangement of components (words and the like) in a sentence of a natural language and an arrangement of a sentence and a sentence in a writing. Examples of the language model capable of performing the natural language processing include bidirectional encoder representations from transformers (BERT), robustly optimized BERT approach (RoBERTa), and Efficiently Learning an Encoder that Classifies Token Replacements Accurately (ELECTRA).

It is assumed that the input data is text data of a question input by the user in a natural language, and the output data is text data indicating an answer to the question in a natural language. For example, the input data may be a question regarding a health condition or health management of the user. As described above, the information processing device 1A can also be used for healthcare application.

Similarly to the first illustrative example embodiment, the generative model used in the present illustrative example embodiment may be a model that generates the output data associated with the input data, and the output data generated by the generative model is freely selected. A format of the input data may be a format associated with the generative model to be used. Therefore, “generative model 2A”, “question”, and “answer” in the following description can be read as freely selected “generative model”, “input data”, and “output data”, respectively.

Similarly to the identification unit 102 of the first illustrative example embodiment, the identification unit 102A identifies a pair of the input data that is a target of content change and the output data generated according to the input data before the content change in the input/output history of the generative model as a non-reference pair that is not referred to in the generation of the output data associated with the input data received by the reception unit 101A. Specifically, the identification unit 102A identifies a pair of a question that is a target of content change and an answer to the question before the content change as a non-reference pair in the input/output history indicating a pair of a question input to the generative model 2A and an answer to the question.

The generation control unit 103A causes the generative model to generate the output data associated with the input data received by the reception unit 101A. For example, the generation control unit 103A causes the generative model 2A to generate an answer to a question received by the reception unit 101A. Although details are described below, the generation control unit 103A can cause the generative model 2A to generate an answer reflecting the input/output history excluding the non-reference pair by causing the generative model 2A to refer to the input/output history excluding the non-reference pair.

The presentation control unit 104A performs processing of performing presentation of various types of information to the user. For example, the presentation control unit 104A performs presentation to the user of the user's question received as input data by the reception unit 101A, and output data associated with the input data, that is, an answer to the question generated by the generative model 2A. A form of the presentation is randomly set. For example, the presentation control unit 104A may perform presentation of information to the user by causing a display device to display and output the information or may perform presentation of information to the user by causing a voice output device to output the information by voice. Hereinafter, an example in which the presentation control unit 104A causes the display device to display and output information is described. The device that outputs information may be a device that is included in the information processing device 1A (for example, the output unit 14A) or may be a device outside the information processing device 1A.

The history management unit 105A manages input/output history of the generative model 2A. For example, the history management unit 105A records a question received by the reception unit 101A and an answer to the question generated by the generative model 2A as the input/output history. A recording destination of the input/output history is freely selected. For example, the history management unit 105A may record the input/output history in the storage unit 11A or may record the input/output history in a database or the like external to the information processing device 1A.

As described above, similarly to the information processing device 1 of the first illustrative example embodiment, the information processing device 1A includes: the reception unit 101A that receives input data (for example, a question input by the user) to the generative model 2A that generates output data associated with the input data, and the identification unit 102A that identifies a pair of input data (for example, a question input in the past) that is a target of content change and output data (for example, an answer to the question input in the past) generated according to the input data before the content change in input/output history of the generative model 2A as a non-reference pair that is not referred to in the generation of the output data (for example, an answer to the question) associated with the input data received by the reception unit 101A. Therefore, an effect of enabling reduction of the possibility that the output data (for example, the answer to the question) generated by the generative model 2A does not conform to the user's intention can be obtained.

As described above, the information processing device 1A includes the generation control unit 103A that causes the generative model 2A to refer to the input/output history excluding the non-reference pair and generate the answer (output data) associated with the question (input data) received by the reception unit 101A. As a result, in addition to the effect exhibited by the information processing device 1, an effect that the user can receive the presentation of the answer (output data) generated without referring to the non-reference pair without performing any operation can be obtained.

### Display Example of Question and Answer

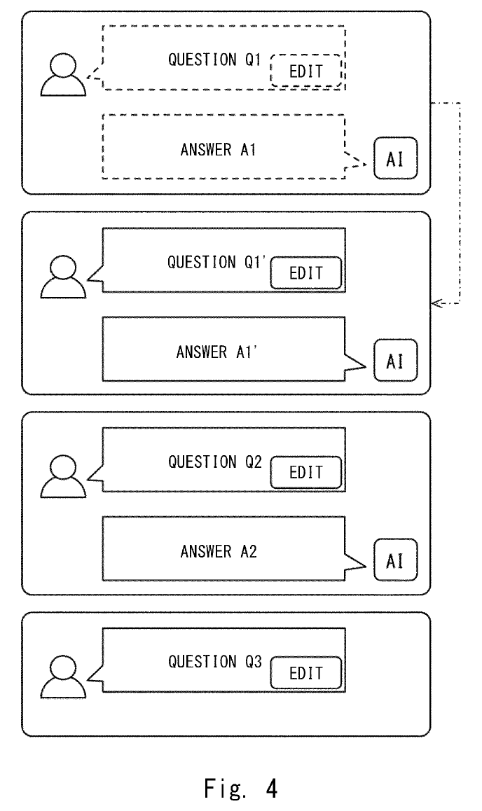

FIG. 4 is a diagram illustrating a display example of a question and an answer by the presentation control unit 104A. In the example of FIG. 4, the presentation control unit 104A arranges and displays a question input by the user and an answer to the question in time series. In other words, the presentation control unit 104A displays a question input by the user and an answer to the question on one timeline.

In the example of FIG. 4, the presentation control unit 104A displays a pair of a question input by the user and an answer to the question in association with each other by surrounding a frame. In each surrounded frame, an icon of the user and an icon of “AI” indicating the generative model 2A are displayed. Then, the question input by the user is displayed in a balloon from the icon of the user, and the answer generated by the generative model 2A is displayed in a balloon from the icon of “AI”.

Here, in the example of FIG. 4, an “edit” button is displayed in the balloon in which the question input by the user is displayed. The “edit” button is a software key for editing the input question. The user can change the content of the question by performing an operation to select an “edit” button displayed in the balloon of the question of which the content is desired to be changed. Then, the user can input the question after the content change and generate an answer to the changed question.

In the example of FIG. 4, after a question Q1 is input, and an answer A1 to the question Q1 is generated, a content of the question Q1 is changed, a question Q1' after the content change is input, and an answer A1' to the question Q1' is generated. After the answer A1' to the question Q1' is generated, a new question Q2 is input, and an answer A2 to the question Q2 is generated. Thereafter, a new question Q3 is input.

Among these pairs of questions and answers, a pair of the question Q1 and the answer A1 is a pair of the question Q1 that is the target of the content change and the answer A1 to the question Q1 before the content change and thus is identified as a non-reference pair by the identification unit 102A. Then, the generation control unit 103A causes the generative model 2A to generate an answer without referring to the non-reference pair identified by the identification unit 102A. Therefore, in the example of FIG. 4, in a case where answers to the question Q2 and the question Q3 are generated, the pair of the question Q1 and the answer A1 is not referred to by the generative model 2A.

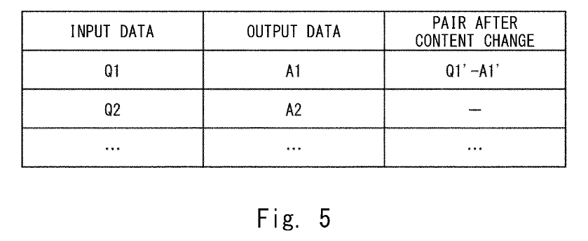

For example, the identification unit 102A may identify a non-reference pair from the input/output history recorded by the history management unit 105A. Then, in a case where the identification unit 102A identifies a non-reference pair from the input/output history, for example, the history management unit 105A may record the input/output history in a format as illustrated in FIG. 5. FIG. 5 is a diagram illustrating an example of the input/output history.

In the input/output history illustrated in FIG. 5, input data input to the generative model 2A and output data generated from the input data are recorded in association with each other. In the input/output history illustrated in FIG. 5, a pair of input data after content change and output data generated from the input data is recorded in a pair of input data that is a target of content change and output data generated from the input data, that is, a non-reference pair, in association with each other.

By recording the input/output history in such a format, the identification unit 102A can identify, as a non-reference pair, a pair in which the pair after the content change is recorded in association. Then, the generation control unit 103A can cause the generative model 2A to generate the output data by referring to the pair after the content change associated with the non-reference pair instead of referring to the non-reference pair identified by the identification unit 102A.

Specifically, in a case where the input/output history as illustrated in FIG. 5 is recorded, if the reception unit 101A receives the input of the question Q3, the identification unit 102A identifies the pair of the question Q1 and the answer A1 as a non-reference pair. Then, among the pair of the question Q1 and the answer A1, the pair of the question Q2 and the answer A2, and the pair of the question Q1' and the answer A1' illustrated in FIG. 5, the generation control unit 103A causes the generative model 2A to refer to the pair of the question Q1' and the answer A1' and the pair of the question Q2 and the answer A2 and generates an answer to the question Q3.

A mode of the input/output history is freely selected and is not limited to the above example. For example, the history management unit 105A may record a non-reference pair and other pairs without distinction. In this case, the identification unit 102A may detect that a content change has been made to input data that has already been input (output data for the input data has already been generated) and record a pair of the input data and output data related to the input data as a non-reference pair separately from the input/output history. For example, a flag may be associated with each pair of a question and an answer recorded in the input/output history. In this case, the identification unit 102A can record that a pair is a non-reference pair by switching the flag of the pair identified as the non-reference pair to ON.

Here, the presentation control unit 104A may perform presentation of the non-reference pair and the other pairs to the user in such a way that the non-reference pair and the other pairs can be distinguished from each other. For example, in the example of FIG. 4, a balloon of the question Q1 that configures the non-reference pair and the answer A1 to the question Q1 is displayed by a broken line. As a result, it is possible to cause the user to recognize that the question Q1 and the answer A1 are the non-reference pair and are not referred to in the generation of the subsequent answer.

The presentation control unit 104A may also perform presentation of the relationship between the non-reference pair and the pair after the content change to the user. Hereinafter, the pair after the content change is referred to as a pair after change. For example, in the example of FIG. 4, an arrow of a one-dot chain line is displayed from the frame surrounding the question Q1 and the answer A1 to the frame surrounding the question Q1' and the answer A1'. As a result, the user can easily recognize that the pair of the question Q1 and the answer A1 is the pair before the content change, that is, the non-reference pair, and the pair of the question Q1' and the answer A1' is the pair after change.

### About Output Data Generation Control

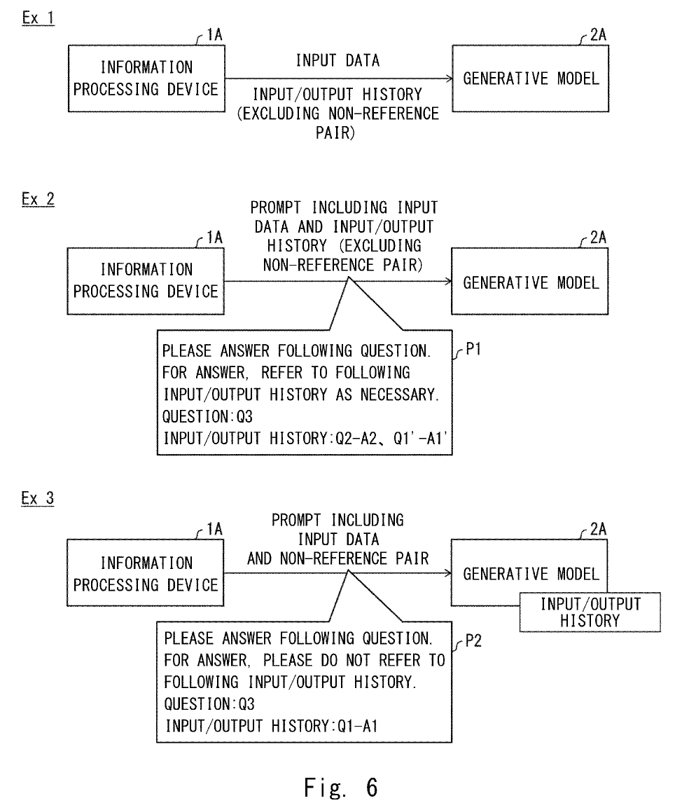

As described above, the generation control unit 103A causes the generative model 2A to refer to the input/output history excluding the non-reference pair and generate output data (answer) associated with the input data (question) received by the reception unit 101A. The method of causing the generative model 2A to refer to the input/output history excluding the non-reference pair may be, for example, a method as illustrated in FIG. 6. FIG. 6 is a diagram illustrating an example of a method of causing the generative model 2A to refer to input/output history excluding the non-reference pair.

FIG. 6 illustrates three examples of Ex1 to Ex3. Ex1 is an example in which the input data and the input/output history are individually input to the generative model 2A. In a case where the method of Ex1 is applied, the generation control unit 103A inputs the input data (question) received by the reception unit 101A to the generative model 2A and also inputs the input/output history (excluding the non-reference pair) to the generative model 2A.

For example, in a case where the input/output history illustrated in FIG. 5 is recorded, the identification unit 102A identifies the pair of the question Q1 and the answer A1 with which the pair after change (the question Q1' and the answer A1') is associated as a non-reference pair among the recorded pairs of the questions and the answers. Then, the generation control unit 103A inputs pairs of questions and answers (including the pairs after change) excluding the pair of the question Q1 and the answer A1 identified as the non-reference pair to the generative model 2A. As a result, it is possible to cause the generative model 2A to refer to the input/output history excluding the non-reference pair in the generation of the answer to the input data (question).

Meanwhile, Ex2 is an example in which the input data and the input/output history are input to the generative model 2A, as one prompt. In a case where the method of Ex2 is applied, the generation control unit 103A generates a prompt including the input data (question) received by the reception unit 101A and the input/output history (excluding the non-reference pair) and inputs the generated prompt to the generative model 2A.

FIG. 6 illustrates a prompt P1 as an example of the prompt including the input data (question) and the input/output history excluding the non-reference pair. The prompt P1 is contents instructing to answer a question and includes a sentence instructing to refer to the input/output history as necessary in the answer. Then, the prompt P1 includes the question Q3 illustrated in FIG. 4 as the question to be answered and includes the pair of the question Q2 and the answer A2 and the pair of the question Q1' and the answer A1' illustrated in FIG. 4 as the input/output history. Meanwhile, the pair of the question Q1 and the answer A1, that is, the non-reference pair, that is the source of the question Q1' and the answer A1' is not included in the input/output history. Therefore, the generation control unit 103A can generate an answer to the question Q3 in consideration of the input/output history excluding the non-reference pair by inputting the prompt P1 to the generative model 2A.

In this manner, the generation control unit 103A may generate the prompt P1 instructing generation of the output data (answer) by using the input/output history excluding the non-reference pair and the input data (question) received by the reception unit 101A and may generate the output data (answer) by inputting the generated prompt P1 to the generative model 2A. As a result, in addition to the effects exhibited by the information processing device 1, it is possible to obtain an effect of enabling the generative model 2A to refer to the input/output history excluding the non-reference pair even in a case where the reference method such as Ex1 cannot be applied in the generation of the output data (answer).

The identification unit 102A may identify a non-reference candidate pair instead of identifying a non-reference pair. In a case where the non-reference candidate pair is identified, the presentation control unit 104A performs presentation of the identified non-reference candidate pair to the user, and the reception unit 101A receives the user's selection for whether to cause the generative model 2A to refer to the presented non-reference candidate pair. Then, the generation control unit 103A may generate the prompt P1 instructing generation of the output data (answer) by using the input/output history excluding the pair that is selected not to be referred to by the generative model 2A from among the non-reference candidate pairs (or those obtained by excluding the pair selected to be referred to from among the non-reference candidate pair) and the input data (question) received by the reception unit 101A. The same applies to Ex3 described below.

Portions other than the contents of the “question” and the “input/output history” in the prompt P1 can be formed as templates. By storing such a template in the storage unit 11A or the like in advance, the generation control unit 103A can generate the prompt P1 by simple processing of incorporating the question and the input/output history in the template. The same applies to a prompt P2 of Ex3 described below.

In Ex3, the generative model 2A stores the input/output history. Therefore, in Ex3, the information processing device 1A inputs the prompt P2 including the input data and the non-reference pair to the generative model 2A. The prompt P2 in Ex3 instructs to answer the question indicated in the input data without referring to the non-reference pair. Therefore, even in a case where the prompt P2 is input to the generative model 2A, similarly to Ex1 and Ex2, it is possible to generate an answer to the question Q3 in consideration of the input/output history excluding the non-reference pair.

In this manner, the generation control unit 103A may generate the prompt P2 instructing to generate the output data (answer) without referring to the non-reference pair or the non-reference candidate pair by using the non-reference pair or the non-reference candidate pair and the input data (question) received by the reception unit 101A, and generate the output data (answer) by inputting the generated prompt P2 to the generative model 2A. Even in a case where such a configuration is adopted, it is possible to obtain an effect of enabling the generative model 2A to refer to the input/output history excluding the non-reference pair or the non-reference candidate pair in the generation of the output data (answer), similarly to Ex2.

### Identification of Non-Reference Candidate Pair

Similarly to the identification unit 102 of the first illustrative example embodiment, the identification unit 102A may identify a non-reference candidate pair instead of identifying a non-reference pair. In a case where the identification unit 102A identifies a non-reference candidate pair, the presentation control unit 104A performs presentation of the identified non-reference candidate pair to the user. The reception unit 101A receives the user's selection for whether to cause the generative model 2A to refer to the presented non-reference candidate pair. Then, if it is selected that the non-reference candidate pair is not referred to by the generative model 2A (also referred to as “if it is not selected that the non-reference candidate pair is referred to”), the generation control unit 103A causes the generative model 2A to refer to the input/output history excluding the non-reference candidate pair and to generate output data (answer) associated with the input data (question) received by the reception unit 101A. As a result, in addition to the effect exhibited by the information processing device 1, an effect that it is possible to leave to the decision making of the user whether to cause the generative model to refer to the non-reference candidate pair can be obtained.

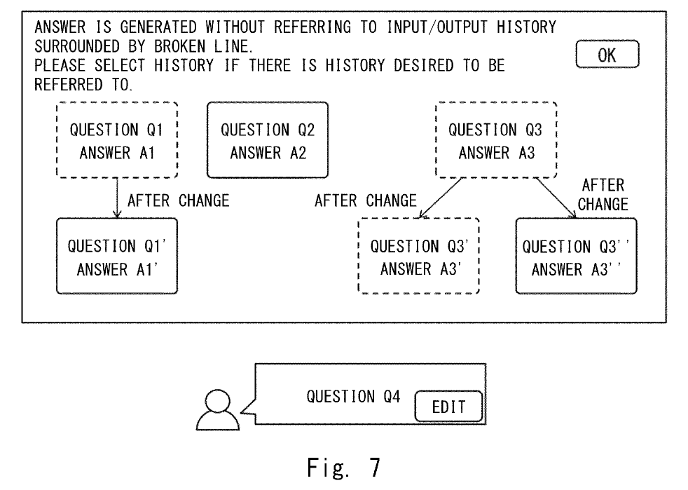

For example, the presentation control unit 104A may perform presentation of the non-reference candidate pair to the user by causing the display device to display a display screen as illustrated in FIG. 7. FIG. 7 is a diagram illustrating an example of a display screen for performing presentation of the non-reference candidate pair to the user. In the screen example of FIG. 7, the input/output history (specifically, each question input to the generative model 2A and an answer to the question) that includes a non-reference candidate pair and can be referred to by the generative model 2A is displayed.

More specifically, in the screen example of FIG. 7, the non-reference candidate pair is surrounded by a dashed-line frame, and a pair of a question and an answer that is not the non-reference candidate pair is surrounded by a solid-line frame. In other words, in the screen example of FIG. 7, each input/output pair is displayed as a node. In a case where both the non-reference candidate pair and the other pair are displayed, the presentation control unit 104A displays the non-reference candidate pair and the other pair in a distinguishable manner as in the example of FIG. 7. This allows the user to recognize which pair is a non-reference candidate pair.

In the screen example of FIG. 7, the non-reference candidate pair and the pair after change related to the non-reference candidate pair are displayed in association with each other. Specifically, in the screen example of FIG. 7, the pair of the question Q1 and the answer A1, that is the non-reference candidate pair, and the pair of the question Q1' and the answer A1', that is the pair after change, are connected by an arrow, and characters “after change” are displayed in association with the arrow. In other words, in the screen example of FIG. 7, a correspondence between nodes before and after change is indicated by an edge (arrow). With such display, it is possible to cause the user to easily recognize the background that the pair of the question Q1 and the answer A1 becomes the target of the content change and the pair of the question Q1' and the answer A1' is obtained by the content change.

In this manner, the presentation control unit 104A may perform presentation to the user of the non-reference candidate pair and the pair after change, that is the pair of the input data after the content change and the output data generated according to the input data after the content change in association with each other. As a result, in addition to the effects exhibited by the information processing device 1, an effect of allowing the user to select whether to cause the generative model 2A to refer to the non-reference candidate pair while allowing the user to recognize the background of the content change can be obtained.

In the screen example of FIG. 7, a pair of the question Q3 and an answer A3 and a pair of a question Q3' and an answer A3' are also displayed as non-reference candidate pairs, and the pair of the question Q3' and the answer A3' and a pair of a question Q3" and an answer A3" are displayed as a pair after change of the question Q3 and the answer A3. That is, in the example of FIG. 7, it is assumed that the content change is performed twice for the pair of the question Q3 and the answer A3. A pair obtained by the first content change is the pair of the question Q3’ and the answer A3’, and a pair obtained by the second content change is the pair of the question Q3" and the answer A3". As in the screen example of FIG. 7, each input/output pair is displayed as a node, and an edge (arrow) is displayed between the nodes in the correspondence relationship before and after the change, so that the user can easily recognize the background of the content change.

In the screen example of FIG. 7, a sentence to generate an answer without referring to the input/output history surrounded by a broken line is displayed, and a sentence to prompt to select history if there is history desired to be referred to is displayed. Then, in the screen example of FIG. 7, an “OK” button (software key) for accepting that the generation of the answer proceeds is displayed.

The reception unit 101A receives selection of a non-reference candidate pair on the display screen. Then, the identification unit 102A re-registers the selected non-reference candidate pair as a pair to be referred to in the generation of the answer by the generative model 2A. For example, in a case where the input/output history is recorded in the format as illustrated in FIG. 5, the identification unit 102A may delete the non-reference candidate pair recorded as the pair after change and re-register the non-reference candidate pair as the normal input/output history. In a case where the non-reference candidate pair (or the non-reference pair) is recorded by the flag, the identification unit 102A may perform processing of switching the flag of the selected non-reference candidate pair from ON to OFF.

Then, if the reception unit 101A receives the operation of the “OK” button, the generation control unit 103A causes the generative model 2A to refer to the input/output history excluding the pair that is the non-reference candidate pair at the time of receiving the operation and generate the output data (answer to the input question).

The timing of displaying the screen that allows the user to select whether to refer to the non-reference candidate pair is freely selected. For example, the display screen of FIG. 7 is displayed at a timing at which a question (specifically, a question Q4) is input by the user. In a case where the presentation control unit 104A displays the display screen at such timing, there is an advantage that the user can confirm and select, for each question, the input/output history to be referred to in the answer to the question and the input/output history not to be referred to. For example, the presentation control unit 104A may display a screen for allowing the user to select whether to refer to a non-reference candidate pair in response to an instruction of the user.

### Condition of Pair as Non-Reference Pair/Non-Reference Candidate Pair

The identification unit 102A may unconditionally identify a pair as the non-reference pair or the non-reference candidate pair as long as the pair is a pair of input data that is a target of content change and output data generated according to the input data before the content change. The identification unit 102A may identify, as the non-reference pair or the non-reference candidate pair, a pair that is a pair of input data that is a target of content change and output data generated according to the input data before the content change and satisfies a predetermined condition. In this way, by adding the condition of the pair identified as the non-reference pair or the non-reference candidate pair, it is possible to easily generate the output data according to the user’s intention.

For example, in a case where topics are the same between a pair of a question and an answer before the change and a pair of a question and an answer after change, if the pair of the question and the answer before change is referred to as the input/output history, it can be said that there is a high possibility that an answer that does not conform to the user’s intention is generated. This is because, in such a case, there is a high possibility that a content of the questions and the answers before change does not conform to the user's intention. Meanwhile, in a case where the topics are different between a pair of a question and an answer before change and a pair of a question and an answer after change, even if the pair of the question and the answer before change is referred as the input/output history, it can be said that there is a low possibility that an answer that does not conform to the user’s intention is generated. This is because, in a case where the topics are different, even if a discrepancy occurs in a pair of questions and answers before and after the change, it is considered that there is a low possibility that the discrepancy is to adversely affect generation of a later answer.

Therefore, the identification unit 102A may identify, as the non-reference pair or the non-reference candidate pair, a pair that is a pair of input data that is a target of content change and output data generated according to the input data before the content change and a pair of input data and output data of which topics are not changed before and after the change. As a result, in addition to the effect exhibited by the information processing device 1, an effect of easily generating output data according to the user’s intention can be obtained.

A method of determining whether the topic has been changed is not particularly limited. For example, the identification unit 102A may determine whether the topic has been changed by using a language model capable of natural language processing. In this case, the identification unit 102A includes a pair before and after the change and may infer whether the topic has been changed before and after the change, generate a prompt for instructing to output the inference result, and input the generated prompt to the language model. As a result, output data indicating whether the topic has been changed before and after the change is output from the language model. The generative model 2A can also be used as this language model. In addition to this, for example, the identification unit 102A can determine whether the topic has been changed by a method such as comparing phrases included in a pair before and after the change.

### Flow of Processing: Recording of Non-Reference Pair or Non-Reference Candidate Pair

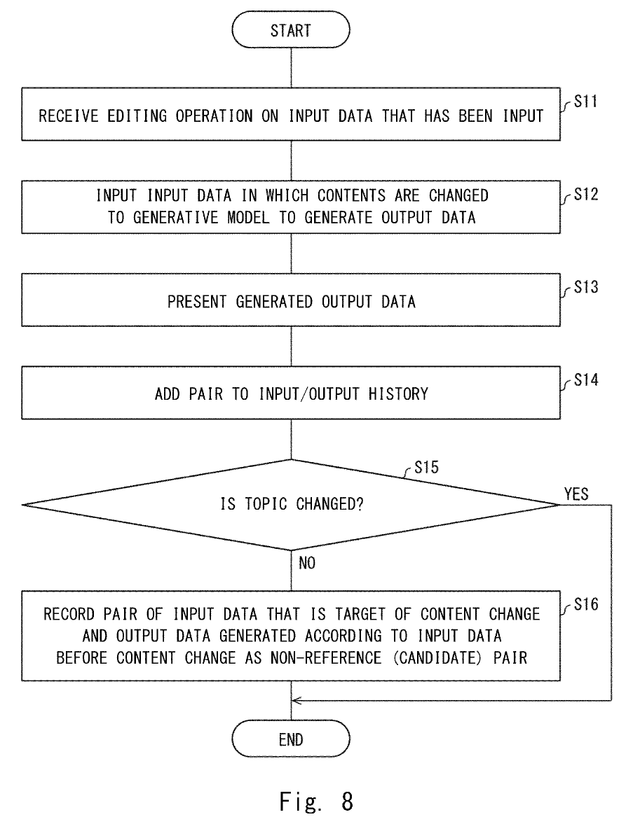

A flow of processing executed by the information processing device 1A is described with reference to FIG. 8. FIG. 8 is a flowchart illustrating a flow of processing in a case where the information processing device 1A records the non-reference pair or the non-reference candidate pair.

In S11, the reception unit 101A receives an editing operation on the input data that has been already input. For example, the reception unit 101A may receive an editing operation on the input data on which the “edit” button is displayed by receiving an operation of selecting the “edit” button in the example of FIG. 4 as a trigger.

In S12, the generation control unit 103A inputs, to the generative model 2A, input data edited by the editing operation received in S11, that is, input data of which content has been changed, and causes the generative model 2A to generate output data. In S13, the presentation control unit 104A performs presentation of the output data generated in S12 to the user. Then, in S14, the history management unit 105A adds a pair of the input data edited in S11 and the output data generated in S13 to the input/output history.

In a case where the input/output history has been already recorded at the time of performing the processing of S12, the generation control unit 103A may cause the generative model 2A to refer to the input/output history in the processing of S12. In S12, the generation control unit 103A may not cause the generative model 2A to refer to the pair of input data before being edited in S11 and the output data.

In S15, the identification unit 102A determines whether the topic has been changed before and after the editing operation in S11. More specifically, the identification unit 102A determines whether the topic is changed between the pair of the input data that is a target of the editing operation in S11 (in other words, a target of content change) and the output data related to the input data, and the pair of the input data after the content change and the output data related to the input data (generated in S12), that is, the pair after change.

In a case where NO is determined in S15, the processing proceeds to S16. In S16, the identification unit 102A records, as the non-reference pair or the non-reference candidate pair, the pair of the input data that is a target of content change and the output data generated according to the input data before the content change. For example, the identification unit 102A may record that the pair is the non-reference pair or the non-reference candidate pair by switching the flag of the pair added to the input/output history in S14 to ON. Accordingly, the illustrated processing ends. Whether to record a pair as a non-reference pair or a non-reference candidate pair may be determined in advance. The user may select whether to record a pair as a non-reference pair or a non-reference candidate pair.

Meanwhile, if YES is determined in S15, the illustrated processing ends without performing the processing of S16. As a result, even if a pair is a pair of input data that is a target of content change and output data generated according to the input data before content change, a pair of which a topic has been changed before and after the change is not recorded as a non-reference pair (and a non-reference candidate pair).

As in the example of FIG. 5, the history management unit 105A may record a non-reference pair and a pair of input data after content change and output data generated from the input data, that is, a pair after change, in association with each other. In this case, after S13, the processing of S15 is performed, and if YES is determined in S15, the history management unit 105A records the non-reference pair and the pair after change in association with each other. In this case, the processing of S16 is not performed.

### Processing Flow: Case where Pair That Is Target of Content Change Is Recorded as Non-Reference Pair

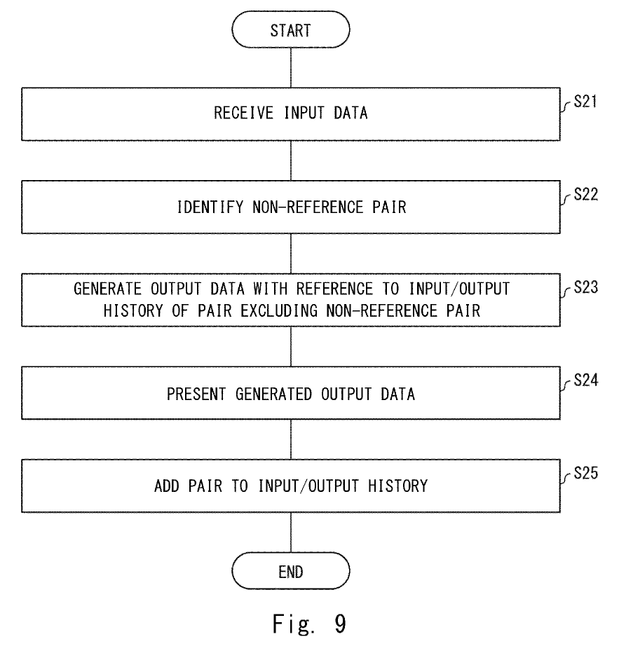

FIG. 9 is a flowchart illustrating a flow of processing executed if the information processing device 1A receives input data in a case where a pair that is a target of content change is recorded as a non-reference pair. The flowchart of FIG. 9 includes each piece of processing of the information processing method according to the present illustrative example embodiment.

In S21 (reception processing), the reception unit 101A receives input data to the generative model 2A. For example, the reception unit 101A may receive input of the input data via the communication unit 12A or the input unit 13A.

In S22 (identification processing), the identification unit 102A specifies a non-reference pair (a pair of input data and output data that is not referred to by the generative model 2A in generation of output data associated with the input data received in S21) from the input/output history of the generative model 2A. More specifically, the identification unit 102A identifies, as the non-reference pair, the pair of the input data that is a target of content change and the output data generated according to the input data before the content change among the pairs of the input data and the output data recorded as the input/output history.

In S23, the generation control unit 103A causes the generative model 2A to generate output data associated with the input data received in S21. At this time, the generation control unit 103A causes the generative model 2A to refer to the input/output history excluding the non-reference pair identified in S22. Note that the generation control unit 103A does not need to cause the generative model 2A to refer to all the input/output history excluding the non-reference pair. For example, the generation control unit 103A may cause the generative model 2A to refer to the latest predetermined number of items of input/output history among the input/output history excluding the non-reference pair or may cause the generative model 2A to refer to the input/output history after start of a session with the user using the generative model 2A.

In S24, the presentation control unit 104A performs presentation of the output data generated in S23 to the user. Then, in S25, the history management unit 105A adds the pair of the input data received in S11 and the output data generated in S23 to the input/output history. Accordingly, the processing of FIG. 9 ends. After S25, in a case where new input data is input, S21 and the subsequent processing are performed again.

### Processing Flow: Case where Pair That Is Target of Content Change Is Recorded as Non-Reference Candidate Pair

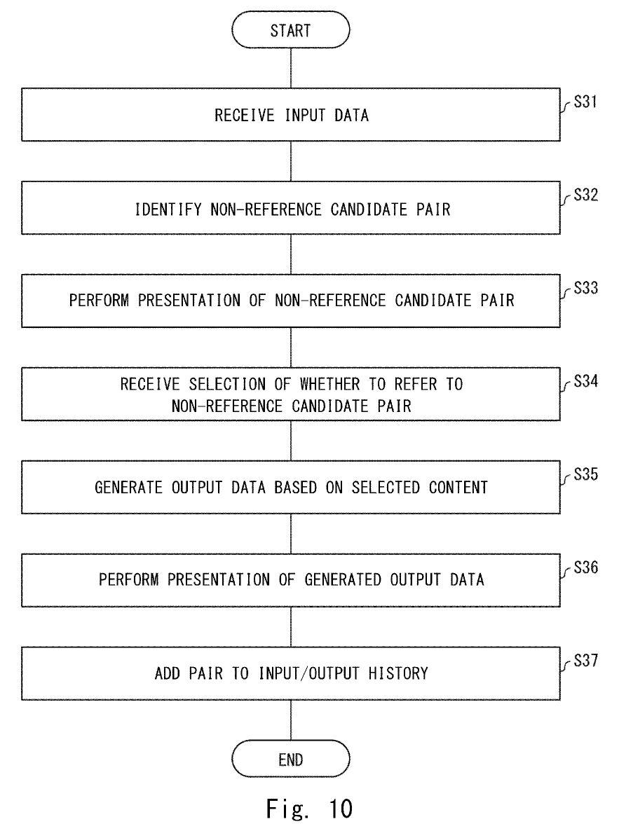

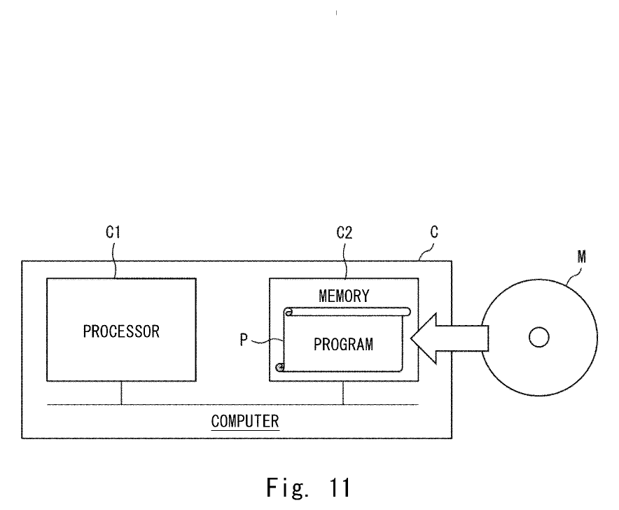

A flowchart of FIG. 10 that is a flowchart illustrating a flow of processing executed in a case where the information processing device 1A receives input data in a case where a pair that is a target of the content change is recorded as a non-reference candidate pair includes each piece of processing of the information processing method according to the present illustrative example embodiment.

In S31 (reception processing), the reception unit 101A receives input data to the generative model 2A. Next, in S32 (identification processing), the identification unit 102A identifies a non-reference candidate pair from the input/output history of the generative model 2A, similarly to the case of identifying a non-reference pair in S22 of FIG. 9.

In S33, the presentation control unit 104A performs presentation of the non-reference candidate pair identified in S32 to the user. For example, the presentation control unit 104A may perform presentation of the non-reference candidate pair to the user by causing the display device to display a display screen as illustrated in FIG. 7.

In S34, the reception unit 101A receives the user's selection for whether to cause the generative model 2A to refer to the non-reference candidate pair presented in S33. In a case where the plurality of non-reference candidate pairs have been presented in S33, the reception unit 101A may receive the user's selection for each non-reference candidate pair.

In S35, the generation control unit 103A causes the generative model 2A to generate output data associated with the input data received in S31 based on the content selected in S34. For example, it is assumed that the display screen of FIG. 7 is displayed in S33. In this case, in S34, the reception unit 101A receives the selection of the non-reference candidate pair and the operation of the “OK” button. Then, in a case where the output data is generated in S35, the generation control unit 103A causes the generative model 2A to refer to the non-reference candidate pair selected to be referred by the user at the time at which the “OK” button is operated together with the input/output history excluding the non-reference candidate pair. In other words, in S35, the generation control unit 103A causes the generative model 2A to refer to the input/output history excluding the non-reference candidate pair and the non-reference candidate pair selected to be referred by the user. Meanwhile, the generation control unit 103A does not cause the generative model 2A to refer to the non-reference candidate pair to which the user has not selected to refer.

In S36, the presentation control unit 104A performs presentation of the output data generated in S35 to the user. Then, in S37, the history management unit 105A adds the pair of the input data received in S31 and the output data generated in S35 to the input/output history. Accordingly, the processing of FIG. 10 ends.

### MODIFIED EXAMPLES

An execution subject of each piece of processing described in the illustrative example embodiments and the reference examples is freely selected and is not limited to the above-described examples. For example, a system having functions similar to those of the information processing devices 1 and 1A can be constructed by a plurality of devices capable of communicating with each other. The execution subject of each piece of processing illustrated in the flowcharts of FIGS. 8 to 10 may be one device (may be rephrased as a processor) or a plurality of devices (may be similarly rephrased as processors).

### EXAMPLE OF IMPLEMENTATION BY SOFTWARE

Some or all functions of the information processing devices 1 and 1A (hereinafter, also referred to as “each of the above devices”) may be implemented by hardware such as an integrated circuit (IC chip) or may be implemented by software.

In the latter case, each of the above devices is implemented by, for example, a computer that executes commands of a program, that is software for implementing each function. An example of such a computer (hereinafter referred to as a computer C) is illustrated in FIG. 11. FIG. 11 is a block diagram illustrating a hardware configuration of the computer C that functions as each of the above devices.

The computer C includes at least one processor C1 and at least one memory C2. A program (information processing program) P for operating the computer C as each of the above devices is recorded in the memory C2. In the computer C, the processor C1 reads the program P from the memory C2 and executes the program P in such a way as to implement each function of each of the above devices.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination of these can be used. As the memory C2, for example, a flash memory, a hard disk drive (HDD), a solid state drive (SSD), or a combination of these can be used.

The computer C may further include a random access memory (RAM) for loading the program P at the time of execution and temporarily storing various types of data. The computer C may further include a communication interface for transmitting and receiving data to and from another device. The computer C may further include an input/output interface for connecting input/output devices such as a keyboard, a mouse, a display, and a printer.

The program P can be recorded in a non-transitory tangible recording medium M readable by the computer C. As such a recording medium M, for example, a tape, a disk, a card, a semiconductor memory, a programmable logic circuit, or the like can be used. The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

Each of the above functions of each of the above devices may be implemented by a single processor provided in a single computer, may be implemented in cooperation with a plurality of processors provided in a single computer, or may be implemented in cooperation with a plurality of processors provided in a plurality of computers. The program for causing each of the above devices to implement each of the above functions may be stored in a single memory provided in a single computer, may be stored in a distributed manner in a plurality of memories provided in a single computer, or may be stored in a distributed manner in a plurality of memories provided in a plurality of computers.

### SUPPLEMENTARY INFORMATION

The present disclosure includes the technologies described in the following Supplementary Notes. However, the present disclosure is not limited to the techniques described in the following Supplementary Notes, and various modifications may be made within the scope described in the claims.

### Supplementary Note A1

An information processing device including: reception means for receiving input data for a generative model that generates output data associated with the input data, and identification means for identifying a pair of input data that is a target of content change and output data generated according to the input data before the content change in input/output history of the generative model, as a non-reference pair not to be referred to in the generation of the output data associated with the input data received by the reception means or a non-reference candidate pair that is a candidate not to be referred to in the generation of the output data associated with the input data received by the reception means.

### Supplementary Note A2

The information processing device according to Supplementary Note A1, further including: generation control means for causing the generative model to refer to the input/output history excluding the non-reference pair and generating the output data associated with the input data received by the reception means.

### Supplementary Note A3

The information processing device according to Supplementary Note A1, further including: presentation control means for performing presentation of the non-reference candidate pair to a user, in which the reception means includes generation control means for receiving the user's selection for whether to cause the generative model to refer to the presented non-reference candidate pair and generating the output data associated with the input data received by the reception means by causing the generative model to refer to the input/output history excluding the non-reference candidate pair, in a case where it is selected to cause the generative model not to refer to the non-reference candidate pair.

### Supplementary Note A4

The information processing device according to Supplementary Note A3, in which the presentation control means performs presentation to the user of the non-reference candidate pair and a pair after change that is a pair of the input data after the content change and the output data generated according to the input data after the content change in association with each other.

### Supplementary Note A5

The information processing device according to any one of Supplementary Notes A2 to A4, in which the generation control means generates a prompt for instructing generation of output data by using the input/output history excluding the non-reference pair or the non-reference candidate pair and the input data received by the reception means, and generates the output data by inputting the generated prompt to the generative model.

### Supplementary Note A6

The information processing device according to any one of Supplementary Notes A2 to A4, in which the generation control means generates a prompt for instructing to generate the output data without referring to the non-reference pair or the non-reference candidate pair by using the non-reference pair or the non-reference candidate pair and the input data received by the reception means, and generates the output data by inputting the generated prompt to the generative model.

### Supplementary Note A7

The information processing device according to any one of Supplementary Notes A1 to A6, in which the identification means identifies, as the non-reference pair or the non-reference candidate pair, a pair that is a pair of input data that is a target of content change and output data generated according to the input data before the content change and is a pair of input data and output data of which a topic has not been changed before and after the change.

### Supplementary Note B1

An information processing method causing at least one processor to perform: reception processing of receiving input data for a generative model that generates output data associated with the input data, and identification processing of identifying a pair of input data that is a target of content change and output data generated according to the input data before the content change in input/output history of the generative model, as a non-reference pair not to be referred to in the generation of the output data associated with the input data received in the reception processing or a non-reference candidate pair that is a candidate not to be referred to in the generation of the output data associated with the input data received in the reception processing.

### Supplementary Note B2

The information processing method according to Supplementary Note B1, causing the at least one processor to further perform: generation control processing of causing the generative model to refer to the input/output history excluding the non-reference pair and generating the output data associated with the input data received in the reception processing.

### Supplementary Note B3

The information processing method according to Supplementary Note B1, further including: presentation control processing performed by the at least one processor for performing presentation of the non-reference candidate pair to a user, reception processing performed by the at least one processor for receiving the user's selection for whether to cause the generative model to refer to the presented non-reference candidate pair, and generation control processing performed by the at least one processor for generating the output data associated with the input data received in the reception processing by causing the generative model to refer to the input/output history excluding the non-reference candidate pair, in a case where it is selected to cause the generative model not to refer to the non-reference candidate pair.

### Supplementary Note B4

The information processing method according to Supplementary Note B3, in which in the presentation control processing, the at least one processor performs presentation to the user of the non-reference candidate pair and a pair after change that is a pair of the input data after content change and the output data generated according to the input data after the content change in association with each other.

### Supplementary Note B5

The information processing method according to any one of Supplementary Notes B2 to B4, in which, in the generation control processing, the at least one processor generates a prompt for instructing generation of output data by using the input/output history excluding the non-reference pair or the non-reference candidate pair and the input data received in the reception processing, and generates the output data by inputting the generated prompt to the generative model.

### Supplementary Note B6

The information processing method according to any one of Supplementary Notes B2 to B4, in which, in the generation control processing, the at least one processor generates a prompt for instructing to generate the output data without referring to the non-reference pair or the non-reference candidate pair by using the non-reference pair or the non-reference candidate pair and the input data received in the reception processing, and generates the output data by inputting the generated prompt to the generative model.

### Supplementary Note B7

The information processing method according to any one of Supplementary Notes B1 to B6, in which, in the identification processing, the at least one processor identifies, as the non-reference pair or the non-reference candidate pair, a pair that is a pair of input data that is a target of content change and output data generated according to the input data before the content change and is a pair of input data and output data of which a topic has not been changed before and after the change.

### Supplementary Note C1

An information processing program causing a computer to function as: reception means for receiving input data for a generative model that generates output data associated with the input data, and identification means for identifying a pair of input data that is a target of content change and output data generated according to the input data before the content change in input/output history of the generative model, as a non-reference pair not to be referred to in the generation of the output data associated with the input data received by the reception means or a non-reference candidate pair that is a candidate not to be referred to in the generation of the output data associated with the input data received by the reception means.

### Supplementary Note C2

The information processing program according to Supplementary Note C1, causing the computer to function as: generation control means for causing the generative model to refer to the input/output history excluding the non-reference pair and generating the output data associated with the input data received by the reception means.

### Supplementary Note C3

The information processing program according to Supplementary Note C1, causing the computer to function as presentation control means for performing presentation of the non-reference candidate pair to a user, in which the reception means receives the user's selection for whether to cause the generative model to refer to the presented non-reference candidate pair and causes the computer to function as generation control means for generating the output data associated with the input data received by the reception means by causing the generative model to refer to the input/output history excluding the non-reference candidate pair, in a case where it is selected to cause the generative model not to refer to the non-reference candidate pair.

### Supplementary Note C4

The information processing program according to Supplementary Note C3, in which the presentation control means performs presentation to the user of the non-reference candidate pair and a pair after change that is a pair of the input data after content change and the output data generated according to the input data after the content change in association with each other.

### Supplementary Note C5

The information processing program according to any one of Supplementary Notes C2 to C4, in which the generation control means generates a prompt for instructing generation of output data by using the input/output history excluding the non-reference pair or the non-reference candidate pair and the input data received by the reception means, and generates the output data by inputting the generated prompt to the generative model.

### Supplementary Note C6

The information processing program according to any one of Supplementary Notes C2 to C4, in which the generation control means generates a prompt for instructing to generate the output data without referring to the non-reference pair or the non-reference candidate pair by using the non-reference pair or the non-reference candidate pair and the input data received by the reception means, and generates the output data by inputting the generated prompt to the generative model.

### Supplementary Note C7

The information processing program according to any one of Supplementary Notes C1 to C6, in which the identification means identifies, as the non-reference pair or the non-reference candidate pair, a pair that is a pair of input data that is a target of content change and output data generated according to the input data before the content change and is a pair of input data and output data of which a topic has not been changed before and after the change.

### Supplementary Note D1

An information processing device including at least one processor, in which the at least one processor performs reception processing of receiving input data for a generative model that generates output data associated with the input data, and identification processing of identifying a pair of input data that is a target of content change and output data generated according to the input data before the content change in input/output history of the generative model, as a non-reference pair not to be referred to in the generation of the output data associated with the input data received in the reception processing or a non-reference candidate pair that is a candidate not to be referred to in the generation of the output data associated with the input data received in the reception processing.

The information processing device may further include a memory. The memory may store a program for causing the at least one processor to execute each piece of processing.

### Supplementary Note D2

The information processing device according to Supplementary Note D1, in which the at least one processor further performs generation control processing of causing the generative model to refer to the input/output history excluding the non-reference pair and generating the output data associated with the input data received in the reception processing.

### Supplementary Note D3

The information processing device according to Supplementary Note D1, in which the at least one processor performs presentation control processing of performing presentation of the non-reference candidate pair to a user, reception processing of receiving the user's selection for whether to cause the generative model to refer to the presented non-reference candidate pair, and generation control processing of generating the output data associated with the input data received in the reception processing by causing the generative model to refer to the input/output history excluding the non-reference candidate pair, in a case where it is selected to cause the generative model not to refer to the non-reference candidate pair.

### Supplementary Note D4

The information processing device according to Supplementary Note D3, in which in the presentation control processing, the at least one processor performs presentation to the user of the non-reference candidate pair and a pair after change that is a pair of the input data after content change and the output data generated according to the input data after the content change in association with each other.

### Supplementary Note D5

The information processing device according to any one of Supplementary Notes D2 to D4, in which, in the generation control processing, the at least one processor generates a prompt for instructing generation of output data by using the input/output history excluding the non-reference pair or the non-reference candidate pair and the input data received in the reception processing, and generates the output data by inputting the generated prompt to the generative model.

### Supplementary Note D6

The information processing device according to any one of Supplementary Notes D2 to D4, in which the generation control means generates a prompt for instructing to generate the output data without referring to the non-reference pair or the non-reference candidate pair by using the non-reference pair or the non-reference candidate pair and the input data received in the reception processing, and generates the output data by inputting the generated prompt to the generative model.

### Supplementary Note D7

The information processing device according to any one of Supplementary Notes D1 to D6, in which, in the identification processing, the at least one processor identifies, as the non-reference pair or the non-reference candidate pair, a pair that is a pair of input data that is a target of content change and output data generated according to the input data before the content change and is a pair of input data and output data of which a topic has not been changed before and after the change.

### Supplementary Note E

A non-transitory recording medium storing an information processing program that causes a computer to function as an information processing device, the program causing the computer to execute: reception processing of receiving input data for a generative model that generates output data associated with the input data, and identification processing of identifying a pair of input data that is a target of content change and output data generated according to the input data before the content change in input/output history of the generative model, as a non-reference pair not to be referred to in the generation of the output data associated with the input data received in the reception processing or a non-reference candidate pair that is a candidate not to be referred to in the generation of the output data associated with the input data received in the reception processing.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

What is claimed is:

1. An information processing device comprising:
at least one memory storing instructions; and
at least one processor configured to execute the instructions to:
receive input data for a generative model that generates output data associated with the input data, and
determine a pair of input data that is a target of content change and output data generated according to the input data before the content change in input/output history of the generative model, as a non-reference pair not to be referred to in the generation of the output data associated with the received input data or a non-reference candidate pair that is a candidate not to be referred to in the generation of the output data associated with the received input data by associating a specific status indicator with the pair within the input/output history stored in the at least one memory.

2. The information processing device according to claim 1, wherein the at least one processor is further configured to execute the instructions to cause the generative model to refer to the input/output history excluding the non-reference pair and generate the output data associated with the received input data.

3. The information processing device according to claim 1, wherein the at least one processor is further configured to execute the instructions to
perform presentation of the non-reference candidate pair to a user,
receive the user's selection for whether to cause the generative model to refer to the presented non-reference candidate pair, and
generate the output data associated with the received input data by causing the generative model to refer to the input/output history excluding the non-reference candidate pair, in a case where it is selected to cause the generative model not to refer to the non-reference candidate pair.

4. The information processing device according to claim 3, wherein the at least one processor is further configured to execute the instructions to perform presentation to the user of the non-reference candidate pair and a pair after change that is a pair of the input data after content change and the output data generated according to the input data after the content change in association with each other.

5. The information processing device according to claim 2, wherein the at least one processor is further configured to execute the instructions to generate a prompt for instructing generation of output data by using the input/output history excluding the non-reference pair or the non-reference candidate pair and the received input data and generate the output data by inputting the generated prompt to the generative model.

6. The information processing device according to claim 2, wherein the at least one processor is further configured to execute the instructions to generate a prompt for instructing to generate the output data without referring to the non-reference pair or the non-reference candidate pair by using the non-reference pair or the non-reference candidate pair and the received input data, and generate the output data by inputting the generated prompt to the generative model.

7. The information processing device according to claim 1, wherein the at least one processor is further configured to execute the instructions to determine, as the non-reference pair or the non-reference candidate pair, a pair that is a pair of input data that is a target of content change and output data generated according to the input data before the content change and is a pair of input data and output data of which a topic has not been changed before and after the change.

8. An information processing method causing at least one processor to perform:
reception processing of receiving input data for a generative model that generates output data associated with the input data; and
determination processing of determining a pair of input data that is a target of content change and output data generated according to the input data before the content change in input/output history of the generative model, as a non-reference pair not to be referred to in the generation of the output data associated with the input data received in the reception processing or a non-reference candidate pair that is a candidate not to be referred to in the generation of the output data associated with the input data received in the reception processing by associating a specific status indicator with the pair within the input/output history stored in the at least one memory.

9. A non-transitory computer-readable medium storing an information processing program that causes a computer to execute:
receiving input data for a generative model that generates output data associated with the input data; and
determining a pair of input data that is a target of content change and output data generated according to the input data before the content change in input/output history of the generative model, as a non-reference pair not to be referred to in the generation of the output data associated with the received input data or a non-reference candidate pair that is a candidate not to be referred to in the generation of the output data associated with the received input data by associating a specific status indicator with the pair within the input/output history stored in the at least one memory.
